(19) United States
(12) Patent Application Publication
(10) Pub. No.: US 2025/0119336 A1
(43) Pub. Date: Apr. 10, 2025

(54) PROBABILISTIC CONSTELLATION SHAPING MODULATION

(71) Applicant: HUAWEI TECHNOLOGIES CO., LTD., Shenzhen (CN)

(72) Inventors: Sha HU, Lund (SE); Sergei SEMENOV, Lund (SE); Dzevdan KAPETANOVIC, Lund (SE)

(21) Appl. No.: 18/981,889

(22) Filed: Dec. 16, 2024

Related U.S. Application Data
(63) Continuation of application No. PCT/EP2022/066580, filed on Jun. 17, 2023.

(51) Int. Cl. H04L 27/36

(52) U.S. Cl. CPC H04L 27/361

(57) ABSTRACT

A communication method includes: modulating a first set of information bits (IB1) into a first number of modulated symbols (MS1) based on a predetermined probability distribution function, mapping a second set of information bits (IB2) into a first number of sign bits (SB1), multiplying the first number of modulated symbols (MS1) with the first number of sign bits (SB1) into a first number of signed modulated symbols (SMS1);
modulating a third set of information bits (IB3) into a second number of modulated symbols (MS2) based on the predetermined probability distribution function, mapping a fourth set of information bits (IB4) into a second number of sign bits (SB2), multiplying the second number of modulated symbols (MS2) with the second number of sign bits (SB2) into a second number of signed modulated symbols (SMS2).

### CROSS-REFERENCE TO RELATED APPLICATIONS

This application is a continuation of International Application No. PCT/EP2022/066580, filed on Jun. 17, 2022, the disclosure of which is hereby incorporated by reference in its entirety.

### TECHNICAL FIELD

Embodiments of invention relates to a first communication device and a second communication device for probabilistic constellation shaping modulation in a communication system. Furthermore, the invention also relates to corresponding methods and a computer program.

### BACKGROUND

Modern communication systems, such as 3GPP 5G New Radio (NR), have evolved into the age of very high modulation order such as 1024-quadrature amplitude modulation (QAM) and 4096-QAM, in order to achieve a high throughput and approach the Shannon capacity in high signal-to-noise (SNR) regime. However, it is known that attaining the Shannon capacity requires the transmitted signal to be Gaussian. In the high SNR regime, the capacity of equiprobable QAM or PAM (pulse amplitude modulation) symbols asymptotically approaches a straight line parallel to the Shannon capacity and shows an SNR loss of 1.53 dB. Therefore, transmitting with equiprobable symbols is not enough, and probabilistic constellation shaping (PCS) which produces a Gaussian-like constellation is a promising method to reduce the gap to the Shannon capacity.

### SUMMARY

An objective of embodiments of the invention is to provide a solution which mitigates or solves the drawbacks and problems of conventional solutions.

Another objective of embodiments of the invention is to provide a modulation scheme which exploits higher throughput compared to conventional solutions.

The above and further objectives are solved by the subject matter of the independent claims. Further embodiments of the invention can be found in the dependent claims.

According to a first aspect of the invention, the above mentioned and other objectives are achieved with a first communication device for a communication system, the first communication device being configured to:
modulate a first set of information bits into a first number of modulated symbols based on a predetermined probability distribution function,
map a second set of information bits into a first number of sign bits,
multiply the first number of modulated symbols with the first number of sign bits into a first number of signed modulated symbols;
modulate a third set of information bits into a second number of modulated symbols based on the predetermined probability distribution function,
map a fourth set of information bits into a second number of sign bits,
multiply the second number of modulated symbols with the second number of sign bits into a second number of signed modulated symbols;
form a set of complex-valued modulated symbols based on the first number of signed modulated symbols and the second number of signed modulated symbols; and
de-map the set of complex modulated symbols into a set of binary bits.

An advantage of the first communication device according to the first aspect is that the mapping of the four sets of information bits is performed in parallel, and is fully compatible with existing communication systems by providing the binary bits after de-mapping as so-called ‘new’ information bit for processing at the first communication device. The existing communication systems may be 3GPP NR but is not limited thereto.

In an implementation form of a first communication device according to the first aspect, the predetermined probability distribution function determines the occurrence of each amplitude in the first number of modulated symbols and in the second number of modulated symbols, respectively, from M number of predefined positive amplitudes.

In an implementation form of a first communication device according to the first aspect, the M number of predefined positive amplitudes are obtained from a pulse amplitude modulation.

The positive amplitudes from a pulse amplitude modulation may comprise symbols {1·\sqrt{β}, 3·\sqrt{β}, . . . , (2M−1)·\sqrt{β}}, where β is a normalization factor and can be set to e.g.,

$$β = \frac{3}{( 2 M - 1 ) ( 2 M + 1 )}$$

such that the average power of all positive amplitudes is 1.

In an implementation form of a first communication device according to the first aspect, the predetermined probability distribution function is a Gaussian or a near Gaussian probability distribution function.

An advantage with this implementation form is that to attain a given entropy, the Gaussian alphabet yields the least average-power of the constellation symbols compared to other symbol distributions. This means that transmit power can be increased proportional to the average-power decrement with the probabilistic constellation shaping, while the effective average transmit-power of the symbols remains unchanged. This means that the throughput can be increased in the communication system.

In an implementation form of a first communication device according to the first aspect, the mapping of the second set of information bits and the fourth set of information bits comprises map an information bit 0 to a sign bit 1 and an information bit 1 to a sign bit −1, or vice versa.

In an implementation form of a first communication device according to the first aspect, the set of complex-valued modulated symbols are quadrature amplitude modulated symbols.

In an implementation form of a first communication device according to the first aspect, the first communication device being configured
encode the set of binary bits into a set of encoded bits;
map the encoded bits into a set of complex-valued modulated symbols; and
transmit the set of complex-valued modulated symbols to a second communication device.

An advantage with this implementation form is that these processing steps are the same as in some existing communication system thereby providing full backwards compatibility with such communication systems.

In an implementation form of a first communication device according to the first aspect, the de-mapping of the set of complex-valued modulated symbols comprises an inverse operation to the mapping of the encoded bits.

In an implementation form of a first communication device according to the first aspect, the first communication device being configured
transmit a control signal to the second communication device, the control signal indicating the predetermined probability density function, and a number of symbols in the first number of modulated symbols and in the second number of modulated symbols.

An advantage with this implementation form is that the control signaling can be performed with low overhead.

In an implementation form of a first communication device according to the first aspect, the predetermined probability density function is represented as a Gaussian distribution.

An advantage with this implementation form is that the Gaussian distribution can be represented by a single parameter which can be signaled to the second communication device.

In an implementation form of a first communication device according to the first aspect, the first communication device being configured
transmit a control signal to the second communication device, the control signal indicating the occurrences of M number of predefined positive amplitudes in the first number of modulated symbols and in the second number of modulated symbols, respectively

An advantage with this implementation form is that the control signaling can be performed with low overhead.

In an implementation form of a first communication device according to the first aspect, the first communication device being configured
transmit a control signal to the second communication device, the control signal indicating a modulation and coding scheme associated with the transmission of the set of complex-valued modulated symbols.

An advantage with this implementation form is that the signaling overhead can be kept at a minimum, and the predetermined probability distribution function or the occurrences of all positive amplitudes can be given by a modulation and coding scheme table that is known to both the first and the second communication devices.

In an implementation form of a first communication device according to the first aspect, the modulating of the first set of information bits and the third set of information bits comprises
split the first set of information bits into a number of first subsets of information bits,
modulate each first subset of information bits into a number of first subsets of modulated symbols based on the predetermined probability distribution function,
combine the first subsets of modulated symbols into the first number of modulated symbols; and
split the third set of information bits into a number of second subsets of information bits,
modulate each second subset of information bits into a number of second subsets of modulated symbols based on the predetermined probability distribution function,
combine the second subsets of modulated symbols into the second number of modulated symbols.

An advantage with this implementation form is that the processing of a large number of information bits may be performed in parallel thereby reducing implementation complexity and decreasing processing time.

According to a second aspect of the invention, the above mentioned and other objectives are achieved with a second communication device for a communication system, the second communication device being configured to:
receive a set of complex-valued modulated symbols from a first communication device;
split the set of complex-valued modulated symbols into a first number of signed modulated symbols and a second number of signed modulated symbols;
split the first number of signed modulated symbols into a first number of sign bits and a first number of modulated symbols,
demodulate the first number of modulated symbols into a first set of information bits based on a predetermined probability distribution function,
demodulate the first number of signed bits into a second set of information bits;
split the second number of signed modulated symbols into a second number of sign bits and a second number of modulated symbols,
demodulate the second number of modulated symbols into a third set of information bits based on the predetermined probability distribution function, and
demodulate the second number of signed bits into a fourth set of information bits.

An advantage of the second communication device according to the second aspect is that the mapping of the four sets of information bits is performed in parallel, and is fully compatible with existing communication systems by providing the binary bits after de-mapping as so-called ‘new’ information bit for processing at the first communication device. The existing communication systems may be 3GPP NR but is not limited thereto.

In an implementation form of a second communication device according to the second aspect, the predetermined probability distribution function determines the occurrence of each amplitude in the first number of modulated symbols and in the second number of modulated symbols, respectively, from M number of predefined positive amplitudes.

In an implementation form of a second communication device according to the second aspect, the M number of predefined positive amplitudes are obtained from a pulse amplitude modulation.

In an implementation form of a second communication device according to the second aspect, the predetermined probability distribution function is a Gaussian or a near Gaussian probability distribution function.

An advantage with this implementation form is that to attain a given entropy, the Gaussian alphabet yields the least average-power of the constellation symbols compared to other symbol distributions. This means that transmit power can be increased proportional to the average-power decrement with the probabilistic constellation shaping, while the effective average transmit-power of the symbols remains unchanged. This means that the throughput can be increased in the communication system.

In an implementation form of a second communication device according to the second aspect,

the demodulating of the first number of signed bits and the second number of signed bits comprises map a sign bit 1 to an information bit 0 and a sign bit −1 to an information bit 1, or vice versa.

In an implementation form of a second communication device according to the second aspect,

the set of complex-valued modulated symbols are quadrature amplitude modulated symbols.

In an implementation form of a second communication device according to the second aspect,

the second communication device being configured to
receive a control signal from the first communication device, the control signal indicating the predetermined probability density function, and the number symbols in the first number of modulated symbols and in the second number of modulated symbols; and
demodulate the first number of signed modulated symbols and the second number of signed modulated symbols based on the control signal.

An advantage with this implementation form is that the control signaling can be performed with low overhead.

In an implementation form of a second communication device according to the second aspect,

the predetermined probability density function is represented as a Gaussian distribution.

An advantage with this implementation form is that the Gaussian distribution can be represented by a single parameter which can be signaled to the second communication device.

In an implementation form of a second communication device according to the second aspect,

the second communication device being configured to
receive a control signal from the first communication device, the control signal indicating the occurrences of M number of predefined positive amplitudes in the first number of modulated symbols and in the second number of modulated symbols, respectively; and
demodulate the first number of signed modulated symbols and the second number of signed modulated symbols based on the control signal.

An advantage with this implementation form is that the control signaling can be performed with low overhead.

In an implementation form of a second communication device according to the second aspect,

the second communication device being configured to
receive a control signal from the first communication device, the control signal indicating a modulation and coding scheme associated with the transmission of the set of complex-valued modulated symbols; and
demodulate the first number of signed modulated symbols and the second number of signed modulated symbols based on the control signal.

An advantage with this implementation form is that the signaling overhead can be kept at a minimum, and the predetermined probability distribution function or the occurrences of all positive amplitudes can be given by a modulation and coding scheme table that is known to both the first and the second communication devices.

In an implementation form of a second communication device according to the second aspect,

the demodulation of the first set of modulated symbols and the second set of modulated symbols comprises
split the first set of modulated symbols into a number of first subsets of modulated symbols,
demodulate each first subset of modulated symbols into a number of first subsets of information bits based on the predetermined probability distribution function,
combine the first subsets of information bits into the first number of information bits; and
split the second set of modulated symbols into a number of second subsets of modulated symbols,
demodulate each second subset of modulated symbols into a number of second subsets of information bits based on the predetermined probability distribution function,
combine the second subsets of information bits into the third number of information bits.

An advantage with this implementation form is that the processing of a large number of information bits may be performed in parallel thereby reducing implementation complexity and decreasing processing time.

According to a third aspect of the invention, the above mentioned and other objectives are achieved with a method for a first communication device, the method comprises:
modulating a first set of information bits into a first number of modulated symbols based on a predetermined probability distribution function,
mapping a second set of information bits into a first number of sign bits,
multiplying the first number of modulated symbols with the first number of sign bits into a first number of signed modulated symbols;
modulating a third set of information bits into a second number of modulated symbols based on the predetermined probability distribution function,
mapping a fourth set of information bits into a second number of sign bits,
multiplying the second number of modulated symbols with the second number of sign bits into a second number of signed modulated symbols;
forming a set of complex-valued modulated symbols based on the first number of signed modulated symbols and the second number of signed modulated symbols; and
de-mapping the set of complex modulated symbols into a set of binary bits.

The method according to the third aspect can be extended into implementation forms corresponding to the implementation forms of the first communication device according to the first aspect. Hence, an implementation form of the method comprises the feature(s) of the corresponding implementation form of the first communication device.

The advantages of the methods according to the third aspect are the same as those for the corresponding implementation forms of the first communication device according to the first aspect.

According to a fourth aspect of the invention, the above mentioned and other objectives are achieved with a method for a second communication device, the method comprises:
receiving a set of complex-valued modulated symbols from a first communication device;
splitting the set of complex-valued modulated symbols into a first number of signed modulated symbols and a second number of signed modulated symbols;
splitting the first number of signed modulated symbols into a first number of sign bits and a first number of modulated symbols,
demodulating the first number of modulated symbols into a first set of information bits based on a predetermined probability distribution function,
demodulating the first number of signed bits into a second set of information bits;
splitting the second number of signed modulated symbols into a second number of sign bits and a second number of modulated symbols,
demodulating the second number of modulated symbols into a third set of information bits based on the predetermined probability distribution function, and
demodulating the second number of signed bits into a fourth set of information bits.

The method according to the fourth aspect can be extended into implementation forms corresponding to the implementation forms of the second communication device according to the second aspect. Hence, an implementation form of the method comprises the feature(s) of the corresponding implementation form of the second communication device.

The advantages of the methods according to the fourth aspect are the same as those for the corresponding implementation forms of the second communication device according to the second aspect.

Embodiments of the invention also relates to a computer program, characterized in program code, which when run by at least one processor causes the at least one processor to execute any method according to embodiments of the invention. Further, embodiments of the invention also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the invention will be apparent from the following detailed description.

### BRIEF DESCRIPTION OF THE DRAWINGS

The appended drawings are intended to clarify and explain different embodiments of the invention, in which:

FIG. 1 shows a first communication device according to an embodiment of the invention;

FIG. 2 shows a flow chart of a method for a first communication device according to an embodiment of the invention;

FIG. 3 shows a second communication device according to an embodiment of the invention;

FIG. 4 shows a flow chart of a method for a second communication device according to an embodiment of the invention;

FIG. 5 shows a communication system according to an embodiment of the invention;

FIG. 6 shows a block diagram of a transmitter and receiver chain according to embodiments of the invention;

FIGS. 7 and 8 illustrates further embodiments of the first communication device; and

FIG. 9 shows a signaling diagram between the first communication device and the second communication device according to embodiments of the invention.

### DETAILED DESCRIPTION

In communication systems, such as 3GPP 5G NR, uniformly distributed QAM symbol constellations are used. Probabilistic constellation shaping (PCS) is not supported in NR but there have been proposals of applying PCS for NR systems. However, mentioned proposals are based on probabilistic amplitude shaping (PAS), which firstly shapes the amplitudes, and then applies a systematic encoder, such as low-density parity check (LDPC) code, to generate parity bits that are mapped as signs of the amplitudes. Such proposals put a stringent constrain on the code-rate of the systematic code, and further the backwards compatibility to current NR system will not be good. Another proposal is to modify the encoder itself to produce coded bits with biased distribution, which however also requires significant changes in the current coding and decoding process in NR.

Therefore, it is herein disclosed a solution comprising a PCS modulation scheme for a communication system, which is clearly defined, flexible, practical, and backwards compatible to existing communication systems, such as the mentioned 5G NR. In addition, related control signaling to support the present PCS modulation scheme is also defined.

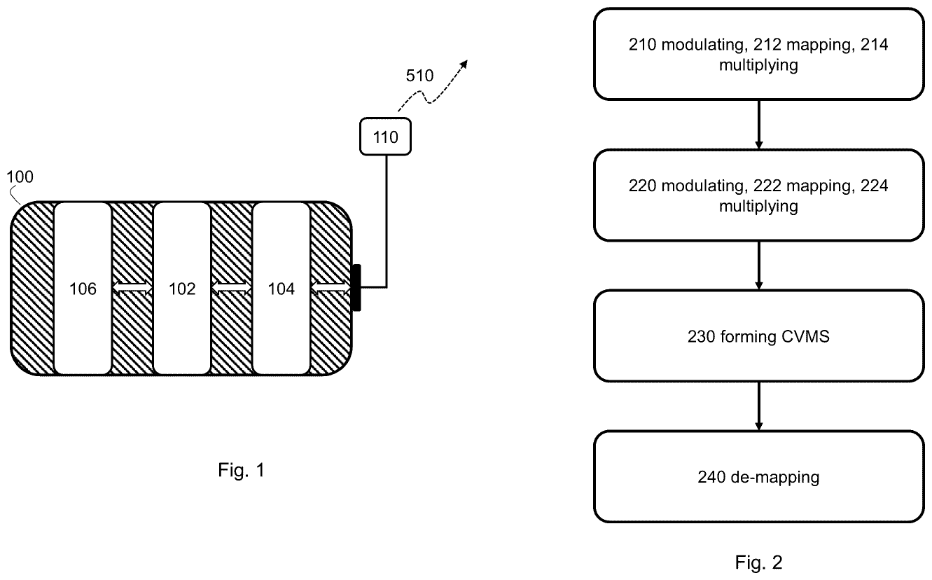

FIG. 1 shows a first communication device 100 according to an embodiment of the invention. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 may be configured for wireless and/or wired communications in a communication system. The wireless communication capability may be provided with an antenna or antenna array 110 coupled to the transceiver 104, while the wired communication capability may be provided with a wired communication interface 112 e.g., coupled to the transceiver 104.

The processor 102 may be referred to as one or more general-purpose CPU, one or more digital signal processor (DSP), one or more application-specific integrated circuit (ASIC), one or more field programmable gate array (FPGA), one or more programmable logic device, one or more discrete gate, one or more transistor logic device, one or more discrete hardware component, or one or more chipsets. The memory 106 may be a read-only memory, a random access memory (RAM), or a non-volatile RAM (NVRAM). The transceiver 304 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset. That the first communication device 100 is configured to perform certain actions can in this disclosure be understood to mean that the first communication device 100 comprises suitable means, such as e.g., the processor 102 and the transceiver 104, configured to perform the actions.

According to embodiments of the invention and with reference to FIG. 1, the first communication device 100 is configured to modulate a first set of information bits IB1 into a first number of modulated symbols MS1 based on a predetermined probability distribution function, map a second set of information bits IB2 into a first number of sign bits SB1, multiply the first number of modulated symbols MS1 with the first number of sign bits SB1 into a first number of signed modulated symbols SMS1. The first communication device 100 is further configured to modulate a third set of information bits IB3 into a second number of modulated symbols MS2 based on the predetermined probability distribution function, map a fourth set of information bits IB4 into a second number of sign bits SB2, multiply the second number of modulated symbols MS2 with the second number of sign bits SB2 into a second number of signed modulated symbols SMS2. The first communication device 100 is further configured to form a set of complex-valued modulated symbols CVMS based on the first number of signed modulated symbols SMS1 and the second number of signed modulated symbols SMS2. The first communication device 100 is further configured to de-map the set of complex modulated symbols 510 into a set of binary bits BB.

FIG. 2 shows a flow chart of a corresponding method 200 which may be executed in a first communication device 100, such as the one shown in FIG. 1. The method 200 comprises modulating 210 a first set of information bits IB1 into a first number of modulated symbols MS1 based on a predetermined probability distribution function, mapping 212 a second set of information bits IB2 into a first number of sign bits SB1, multiplying 114 the first number of modulated symbols MS1 with the first number of sign bits SB1 into a first number of signed modulated symbols SMS1. The method 200 further comprises modulating 220 a third set of information bits IB3 into a second number of modulated symbols MS2 based on the predetermined probability distribution function, mapping 222 a fourth set of information bits IB4 into a second number of sign bits SB2, multiplying 224 the second number of modulated symbols MS2 with the second number of sign bits SB2 into a second number of signed modulated symbols SMS2. The method 200 further comprises forming 230 a set of complex-valued modulated symbols CVMS based on the first number of signed modulated symbols SMS1 and the second number of signed modulated symbols SMS2. The method 200 further comprises de-mapping 240 the set of complex modulated symbols 510 into a set of binary bits BB.

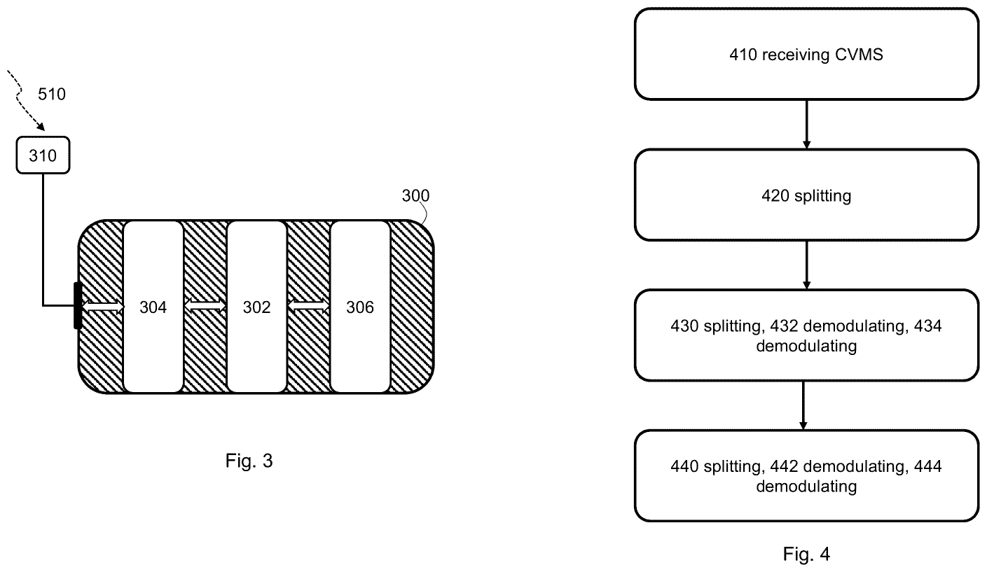

FIG. 3 shows a second communication device 300 according to an embodiment of the invention. In the embodiment shown in FIG. 3, the second communication device 300 comprises a processor 302, a transceiver 304 and a memory 306. The processor 302 is coupled to the transceiver 304 and the memory 306 by communication means 308 known in the art. The second communication device 300 further comprises an antenna or antenna array 310 coupled to the transceiver 304, which means that the second communication device 300 is configured for wireless communications in a communication system.

The processor 302 may be referred to as one or more general-purpose CPU, one or more digital signal processor (DSP), one or more application-specific integrated circuit (ASIC), one or more field programmable gate array (FPGA), one or more programmable logic device, one or more discrete gate, one or more transistor logic device, one or more discrete hardware component, one or more chipset. The memory 306 may be a read-only memory, a random access memory (RAM), or a non-volatile RAM (NVRAM). The transceiver 104 may be a transceiver circuit, a power controller, or an interface providing capability to communicate with other communication modules or communication devices. The transceiver 304, the memory 306 and/or the processor 302 may be implemented in separate chipsets or may be implemented in a common chipset. That the second communication device 300 is configured to perform certain actions can in this disclosure be understood to mean that the second communication device 300 comprises suitable means, such as e.g., the processor 302 and the transceiver 304, configured to perform the actions.

According to embodiments of the invention and with reference to FIG. 3, the second communication device 300 is configured to receive a set of complex-valued modulated symbols 510 from a first communication device 100. The second communication device 300 is further configured to split the set of complex-valued modulated symbols 510 into a first number of signed modulated symbols SMS1 and a second number of signed modulated symbols SMS2. The second communication device 300 is further configured to split the first number of signed modulated symbols SMS1 into a first number of sign bits SB1 and a first number of modulated symbols MS1, demodulate the first number of modulated symbols MS1 into a first set of information bits IB1 based on a predetermined probability distribution function, demodulate the first number of signed bits SB into a second set of information bits IB2. The second communication device 300 is further configured to split the second number of signed modulated symbols SMS2 into a second number of sign bits SB2 and a second number of modulated symbols MS2, demodulate the second number of modulated symbols MS2 into a third set of information bits IB3 based on the predetermined probability distribution function, and demodulate the second number of signed bits SB2 into a fourth set of information bits IB4.

FIG. 4 shows a flow chart of a corresponding method 400 which may be executed in a second communication device 300, such as the one shown in FIG. 3. The method 400 comprises receiving 410 a set of complex-valued modulated symbols 510 from a first communication device 100. The method 400 further comprises splitting 420 the set of complex-valued modulated symbols 510 into a first number of signed modulated symbols SMS1 and a second number of signed modulated symbols SMS2. The method 400 further comprises splitting 430 the first number of signed modulated symbols SMS1 into a first number of sign bits SB1 and a first number of modulated symbols MS1, demodulating 432 the first number of modulated symbols MS1 into a first set of information bits IB1 based on a predetermined probability distribution function, demodulating 434 the first number of signed bits SB into a second set of information bits IB2. The method 400 further comprises splitting 440 the second number of signed modulated symbols SMS2 into a second number of sign bits SB2 and a second number of modulated symbols MS, demodulating 442 the second number of modulated symbols MS2 into a third set of information bits IB3 based on the predetermined probability distribution function, and demodulating 444 the second number of signed bits SB2 into a fourth set of information bits IB4.

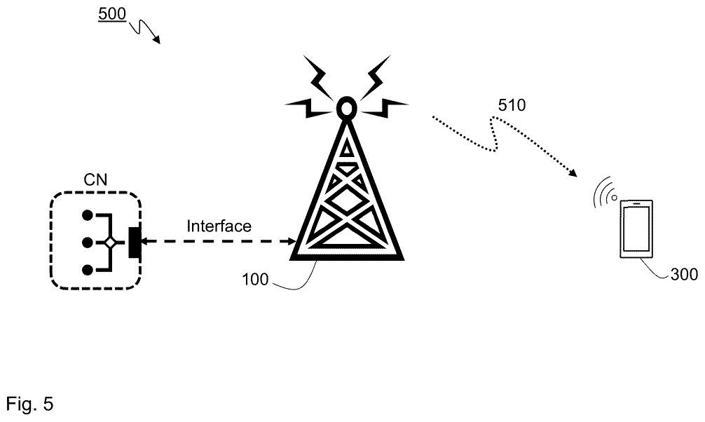

FIG. 5 shows a communication system 500 according to embodiments of the invention. The communication system 500 in the disclosed example comprises a first communication device 100 and a second communication device 300 configured to communicate and operate in the communication system 500. The first communication device 100 in this particular example acts as a network access node, such as a base station, and may hence be connected to a core network (CN) via a suitable communication interface and being part of a RAN. The second communication device 300 on the other hand acts as a client device, such as a user equipment (UE). The first communication device 100 may communicate with the second communication device 300, or vice versa, using downlink (DL) and uplink (UL) communications, e.g., via the Uu interface. It should however be noted that embodiments of the invention are not limited to the architecture exemplified in FIG. 5. Furthermore, for simplicity the shown communication system 500 only comprises one first communication device 100 and one second communication device 300. However, the communication system 500 may comprise any number of first communication devices 100 and any number of second communication devices 300 without deviating from the scope of the invention.

With reference to FIG. 5, the first communication device 100 performs a transmission 510 in the downlink to the second communication device 300. The first communication device 100 is therefore configured to encode a set of binary bits BB into a set of encoded bits EB. Thereafter, to map the encoded bits EB into a set of complex-valued modulated symbols 510 and to finally transmit the set of complex-valued modulated symbols 510 to the second communication device 300. It may be noted that the de-mapping of the set of complex-valued modulated symbols CVMS comprises an inverse operation to the mapping of the encoded bits EB. The second communication device 300 is configured to receive the transmission 510 comprising the complex-valued modulated symbols and process the complex-valued modulated symbols CVMS accordingly which will be explained in the following disclosure.

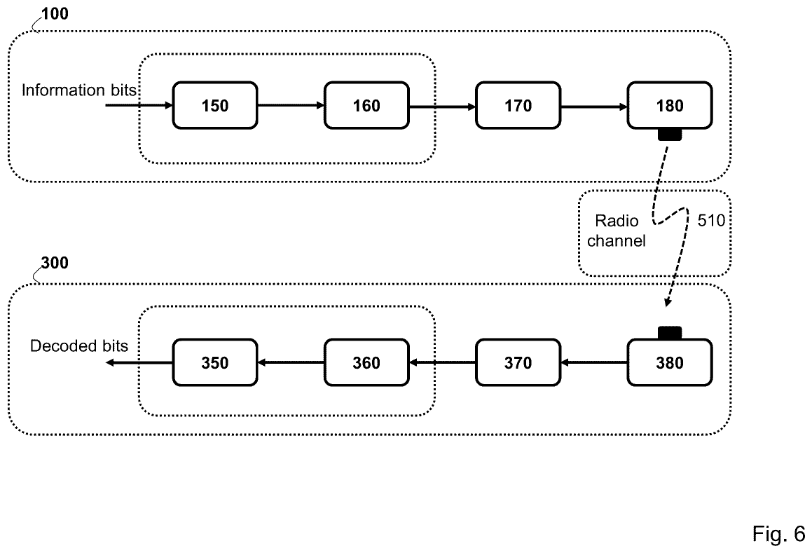

FIG. 6 shows a block diagram of a transmitter chain and a receiver chain, respectively, according to embodiments of the invention. The first communication device 100 comprises two processing blocks (or steps) prior to the conventional systematic encoder block 170 compared to a conventional NR transmitter that generates uniformly distributed QAM symbols. The first processing block is a PCS modulation block 150, which generates N number of complex-valued QAM symbols for each 2(K+N) number of binary information bits. The N complex-valued QAM symbols are de-mapped into 2(N+log₂ M) number of binary bits in the de-mapper block 160 following the PCS modulation block 150. The de-mapping may e.g., be performed according to so called Gray labelling used in NR or any other suitable de-mapping scheme. The binary bits outputted from the de-mapper block 160 are forwarded to the systematic encoder block 170 which outputs coded bits to the mapper block 180 that is configured to map the coded bits from the systematic encoder 170 into complex-valued QAM symbols. The first communication device 100 thereafter transmits a communication signal 510 comprising the complex-valued QAM symbols over a radio channel to the second communication device 300.

At the receiver side, the second communication device 300 receives the communication signal 510 comprising the complex-valued QAM symbols from the first communication device 100. The second communication device 300 initiates a detection procedure in the detection block 380. For example, the second communication device 300 estimate a set of log-likelihood ratios (LLRs) and decodes the set of LLRs into a set of decoded binary bits. If the decoding succeeds without error in the set of decoded binary bits, the second communication device 300 continues to the mapper block 360 and the PCS demodulation block 350, i.e., the inverse operations of the PCS operations implemented at the first communication device 100. However, if the decoding fails without error(s) in the set of decoded binary bits, the second communication device 300 may report a block error to the first communication device 100, and skip mentioned mapper block 360 and PCS demodulation block 350. The block error reporting to the first communication device 100 may be performed according to a HARQ procedure known in the art.

The inverse operations to the operations performed in the first communication device 100 are implemented in the mapper block 360 and in the PCS demodulation block 350, respectively. The mapper block 360 is configured to map the correctly decoded bits into a vector comprising QAM symbols. The PCS demodulation block 350 receives the vector of QAM symbols and performs an inverse DM operation to recover the transmitted information bits which are outputted as decoded bits at the second communication device 300.

Hence, it is herein disclosed a solution that makes it possible to keep the current NR transmitter chain unaltered with only adding a PCS modulation block 150 and a de-mapper block 160 before the systematic encoder 170 at the transmitter side. The PCS modulation block 150 processes a vector of input information bits into a vector of complex-valued QAM symbols, which applies two separate distribution matchers (DMs) in parallel, such as using arithmetic encoding, to shape the amplitudes of the real and imaginary parts of a complex-valued QAM symbol to follow the given predetermined probability distribution function. The predetermined probability distribution function, such as a Gaussian or a near Gaussian probability distribution function, determines the occurrence of each amplitude in the first number of modulated symbols and in the second number of modulated symbols, respectively, from M number of predefined positive amplitudes. The M number of predefined positive amplitudes may be obtained from a pulse amplitude modulation as previously described.

The first and second sign bits SB1, SB2 are generated from information bits by a mapping procedure in which the mapping of the second set of information bits IB2 and the fourth set of information bits IB4 comprises mapping an information bit 0 to a sign bit 1 and an information bit 1 to a sign bit −1, or vice versa. This may e.g., be achieved with BPSK or any other suitable mapping scheme. Finally, these four parts, i.e., the amplitudes of the real and imaginary parts and signs of the real and imaginary parts are combined together to create the shaped constellation QAM symbols. Afterwards, these QAM symbols are de-mapped into binary bits in the de-mapper block 160, and fed to the systematic encoder 170, which implies that all remaining processes or steps at transmission in NR can be unchanged. Such a general design yields a good backwards compatibility and also only requires small modifications to an existing communication system that only supports uniformly distributed symbol constellations.

For those systems where scrambling and interleaving are implemented at the coded bits produced by the systematic encoder, inverse operations may be further considered accordingly on the de-mapped bits to preserve the order of bits when it maps back to shaped QAM constellation symbols. On the other hand, since the parity bits, such as outputted from a LDPC encoder, is close to uniformly distributed, these parity bits are mapped to different constellation symbols with equal probability. Therefore, PCS is most useful with high code-rates such that the overall distribution of constellation symbols after encoding is still close to Gaussian.

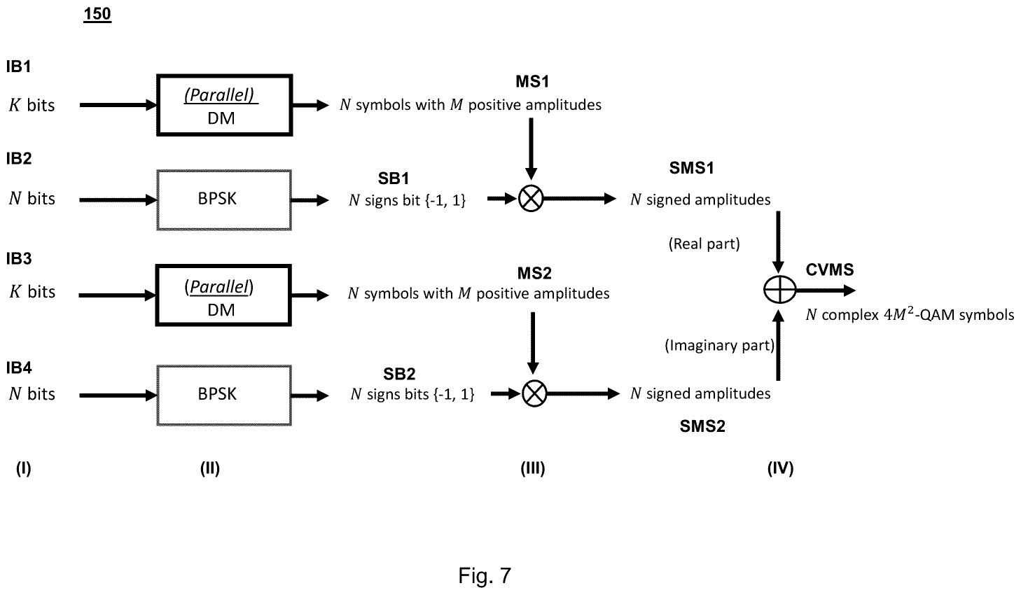

Moreover, FIG. 7 discloses the present PCS modulation block 150 more in detail according to further embodiments of the invention.

In step I in FIG. 7, an input stream comprising of 2(K+N) information bits are split into four parts, i.e., two streams of length K number of information bits denoted the first and third set of information bits IB1, IB3, and two streams of length N number of information bits denoted the second and fourth set of information bits IB2, IB4.

In step II in FIG. 7, the two streams of K number of information bits are mapped, respectively, to output first number of modulated symbols MS1 and the second number of modulated symbols MS1. The mapping may be performed through a standard DM block, which maps an input length K binary bit sequence into a length N vector that comprises of M positive amplitudes e.g., {1·\sqrt{β}, 3·\sqrt{β}, . . . , (2M−1)·\sqrt{β}}, multiplying with a normalization factor, where typically M>1 is a power of 2, such that log₂ M is an integer.

In step II in FIG. 7, the two streams of N number of information bits are also mapped e.g., by using BPSK, i.e., an input bit 0 is mapped to −1, and an input bit 1 is mapped to 1, or vice visa.

In step III in FIG. 7, each N number of amplitudes are thereafter multiplied with the N sign bits generated from BPSK mapping, and output a length N vector that comprises signed 2M-PAM symbols, i.e., the first number of signed modulated symbols SMS1 and the second number of signed modulated symbols SMS2.

In step IV in FIG. 7, the first number of signed modulated symbols SMS1 and the second number of signed modulated symbols SMS2 are combined into the real part and the imaginary part, respectively, of a length N vector that comprises a set of 4M²-QAM number of complex-valued modulated symbols CVMS, when the set of complex-valued modulated symbols CVMS are quadrature amplitude modulated symbols.

For instance, for 256-QAM modulation, it holds that M=8 and log₂ M=3, while for 1024-QAM modulation, it holds that M=16 and log₂ M=4. Hence, on average each complex-valued QAM symbol carries 2+K/N number of bits. Lastly, the 4M²-QAM number of complex-valued modulated symbols CVMS are de-mapped in a demapper block 160 into a set of binary bits as have been explained with reference to FIG. 6.

As aforementioned, a DM block maps an input length K binary bit sequence into a length N vector that comprises M positive amplitudes, and the probability distribution function (pdf) of the M positive amplitudes is following a Gaussian or a near Gaussian distribution. Such a pdf can be predetermined and adapted according to the transmission conditions such as the channel characteristics, SNR, modulation-order, code-rate, etc. In general, a discrete Gaussian distribution may be used as

$$\begin{matrix}p ( {A}_{m} ) = \frac{1}{α} {e}^{- v {A}_{m}^{2}} , & 1 \leq m \leq M\end{matrix} \qquad Eq . l$$

for the mth amplitude Aₘ from a predetermined set {A₁, A₂, . . . , A_{M}}, for instance it can be set that Aₘ=(2m−1)\sqrt{β}. The normalization factor a equals to

$$a = {\sum }_{i = 1}^{M} {e}^{- v {A}_{i}^{2}} . \qquad Eq . 2$$

such that Σₘ₌₁^{M}p(Aₘ)=1.

In this case, the parameter v determines the pdf and may be considered as a design parameter. For instance, if v=0, then p(Aₘ)=1/M for all amplitudes which follows a uniform distribution. With a uniform distribution, the average power of all constellation symbols is normalized to 1. As the value of v increases, the transmission probabilities of a constellation symbols increase as its amplitude decreases, which yields a smaller average power ε that equals to

$$ℰ = {\sum }_{m = 1}^{M} p ( {A}_{m} ) {A}_{m}^{2} \qquad Eq . 3$$

Meanwhile, the entropy H (in natural unit of information) equals

$$\begin{matrix}H = - {\sum }_{m = 1}^{M} p ( {A}_{m} ) ln p ( {A}_{m} ) \\ = - ln a + v {\sum }_{m = 1}^{M} p ( {A}_{m} ) {A}_{m}^{2} \\ = v ℰ - ln a ,\end{matrix} \qquad Eq . 4$$

where ‘ln’ denotes the natural logarithm, and a is defined in Eq. 2. With the PCS, the number of bits carried by each amplitude is reduced. Therefore, there is a trade-off between the entropy and average power. Nevertheless, it is known that to attain a given entropy in Eq. 4 the Gaussian distribution minimizes the averaged power in Eq. 3.

Now assuming that the DM block generates a length N vector that comprises M positive amplitudes, the occurrences Nₘ of each amplitude Aₘ is equal to p(Aₘ) i.e.,

$${N}_{m} = N p ( {A}_{m} ) \qquad Eq . 5$$

Note that Nₘ must be an integer, and an adjustment to the amplitude p(Aₘ) may be required, based on principles such as minimizing the Kullback-Leibler (KL) divergence i.e.

$${D}_{K L} ( p \vert q ) = {\sum }_{m = 1}^{M} p ( {A}_{m} ) ln \frac{p ( {A}_{m} )}{q ( {A}_{m} )} , \qquad Eq . 6$$

between the original pdf p=(p(A₁), p(A₂), . . . , p(A_{M})) and a revised pdf q=(q(A₁), q(A₂), . . . , q(A_{M})) such that Nₘ=Nq(Aₘ) are all integers.

Nevertheless, we may assume that with an appropriate adjustment, all Nₘ are integers.

Then, considering all possible length N vectors such that amplitude Aₘ exactly appears Nₘ times, the number of all such vectors is equal to

$$S = ( \begin{matrix}N \\ {N}_{1} , {N}_{2} , … , {N}_{M}\end{matrix} ) = \frac{N !}{{N}_{1} ! {N}_{2} ! … {N}_{M} !} . \qquad Eq . 7$$

Therefore, it can support K=└log₂ S┘ number of information bits to be able to index each input vector to such an output vector, where the operation ‘└log₂ S┘’ takes the largest integer that is no larger than └log₂ S┘. For instance, consider a case when the DM block outputs a vector of length N=24, and the four amplitudes appear {12,6,4,2} times, respectively. Then, in total the number of sequences satisfying this is

$$S = ( \begin{matrix}24 \\ 12 , 6 , 4 , 2\end{matrix} )$$

and the maximal number of input information bit will be

K=└log₂ S┘=35.

In this non-limiting example p={0.5, 0.25, 0.17, 0.08}, and the entropy is H=1.726 bits. While for N=24, K=N, H=41.42 bits can in theory be carried, which is larger than 35 bits. This is because the length N in this case is small, and for K/N to be able to approach H, N should be sufficiently large.

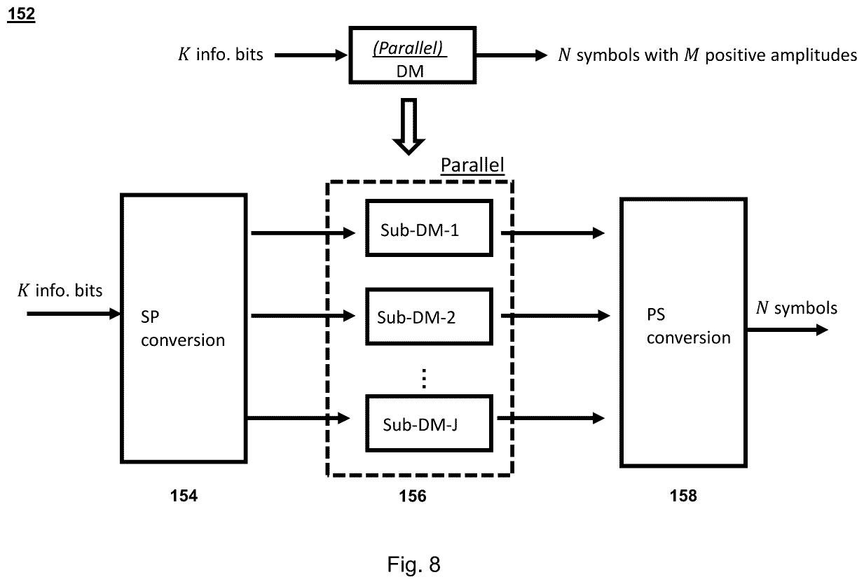

Further embodiments of the invention for the DM operation are illustrated in FIG. 8. In this embodiment illustrated with block 152, an input sequence of K bits can be split into J number of subsequences, and each subsequence can pass through a sub-DM operation block in parallel. Such an approach is suboptimal compared to directly apply a DM operation on the whole sequence, but it reduces complexity and latency of the DM operation.

The first communication device 100 will split the first set of information bits IB1 into a number of first subsets of information bits in the serial to parallel conversion block 154. Each first subset of information bits will be modulated into a number of first subsets of modulated symbols based on the predetermined probability distribution function in the parallel sub-DM blocks 156, Sub-DM-1, Sub-DM-2, Sub-DM-J. The first subsets of modulated symbols from the parallel sub-DM blocks 156 will be combined into the first number of modulated symbols MS1 in the parallel to serial block 158. Correspondingly, first communication device 100 will also split the third set of information bits IB3 into a number of second subsets of information bits, modulate each second subset of information bits into a number of second subsets of modulated symbols based on the predetermined probability distribution function, and combine the second subsets of modulated symbols into the second number of modulated symbols MS2.

Not shown in the Figs, but the second communication device 100 will perform the corresponding inverse operations. That is, for demodulating the first set of modulated symbols MS1 and the second set of modulated symbols MS2, the second communication device 100 will split the first set of modulated symbols MS1 into a number of first subsets of modulated symbols. Each first subset of modulated symbols is modulated into a number of first subsets of information bits based on the predetermined probability distribution function. The first subsets of information bits are thereafter combined into the first number of information bits IB1. Correspondingly, the second communication device 100 will also split the second set of modulated symbols MS2 into a number of second subsets of modulated symbols, demodulate each second subset of modulated symbols into a number of second subsets of information bits based on the predetermined probability distribution function, and thereafter combine the second subsets of information bits into the third number of information bits IB3.

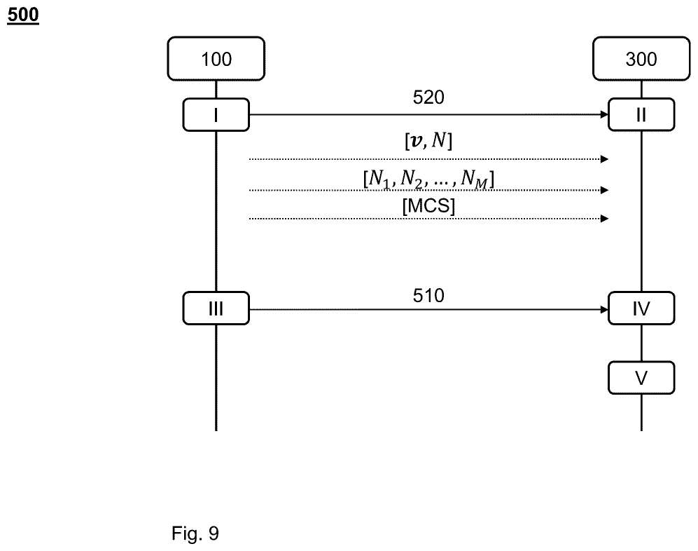

In the following section and with reference to FIG. 9, related control signaling between the first communication device 100 and the second communication device 300 will be introduced. The control signaling may be any control signaling that conform to different communication standards. In 3GPP NR such control signaling may be RRC, MAC CE, etc. performed over physical control channels.

The first communication device 100 transmit a control signal 520 in step I in FIG. 9 which is received by the second communication device 300 in step Il in FIG. 9. The second communication device 100 receives a communication signal 510 in step IV in FIG. 9 previously transmitted by the first communication device 100 in step III in FIG. 9. The communication signal 510 comprises the set of complex-valued modulated symbols in step IV and process the received communication signal 510 in step V in FIG. 9. The second communication device 100 first decodes the communication signal 510 by treating it as normally modulated QAM symbols, and after successful decoding, the second communication device 100 needs to map the decoded bits to a vector of QAM symbols, and then vector of QAM symbols is decoded by an inverse DM operation to obtain the original information bits. The required knowledge for the receiver to operate the inverse DM operation is all values of Nₘ, or equivalently, the target pdf p and the output length N of the DM.

Therefore, in an embodiment of the invention, the pair of parameters v, N can be assigned to the second communication device by assuming the pdf follows the Gaussian distribution in Eq. 1, together with some agreed adjustments to make all Nᵢ to be integers. In other words, the first communication device 100 transmits a control signal 520 to the second communication device 300, where the control signal 520 indicates the predetermined probability density function, and the number symbols N in the first number of modulated symbols MS1 and in the second number of modulated symbols MS2. In examples of the invention, the predetermined probability density function may be represented as a Gaussian distribution in the mentioned control signaling.

In another embodiment, the values indicating the occurrences of M number of predefined positive amplitudes are signaled to the second communication device 100 e.g., with standard compression technics such as differential encoding to reduce the payload size. Hence, the first communication device 100 in this example transmits a control signal 520 to the second communication device 300, where the control signal 520 indicates the occurrences of M number of predefined positive amplitudes {N₁, N₂, . . . , N_{M}} in the first number of modulated symbols MS1 and in the second number of modulated symbols MS2, respectively.

In yet another embodiment the modulation and coding schemes (MCSs) of NR are extended. Therefore, the first communication device 100 may transmit a control signal 520 to the second communication device 300, and the control signal 520 indicates a MCS associated with the transmission of the set of complex-valued modulated symbols 510.

In NR, the MCS for a certain transmission is determined via higher layer signaling, such as RRC signaling, using MCS tables. Instead of the explicit signaling of the PCS parameters according to the previous embodiments in this regard, an alternative is to modify the MCS tables to directly indicate the information needed by the second communication device 300 as illustrated in Table 1. The current MCS table for each MCS index (X) in NR contains information of modulation order (Q), target code-rate (R), and spectral efficiency (Y). An additional parameter can be added in MCS table e.g., in the form of [N₁, N₂, . . . , N_{M}], where M as aforementioned equals to the number of different positive amplitudes in real or imaginary dimension for a given modulation order. Alternatively, the additional parameter can be given in the form of [p₁, p₂, . . . , p_{M}] and N, where pₘ=p(Aₘ) is the probability for each positive amplitude, and N is the total length of DM output vector. In yet another alternatively, by assuming the MB distribution is applied, the additional parameter can also be given in the form [v, N].

TABLE 1
proposed extension of MCS table.

| MCS | Modulation | Target | Spectral | |
|---|---|---|---|---|
| index | order | code rate | efficiency | Additional parameter |
| X | Q | R | Y | [N₁, N₂, . . . , N_{M}] |
| | | | | or |
| | | | | [p₁, p₂, . . . , p_{M}] and N |
| | | | | or |
| | | | | [v, N] |

A network access node herein may also be denoted as a radio first communication device, an access first communication device, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio first communication devices may be of different classes or types such as e.g., macro eNodeB, home eNodeB or pico base station, based on transmission power and thereby the cell size. The radio first communication device may further be a station (STA), which is any device that contains an IEEE 802.11-conformant media access control (MAC) and physical layer (PHY) interface to the wireless medium (WM). The radio first communication device may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station (STA), which is any device that contains an IEEE 802.11-conformant media access control (MAC) and physical layer (PHY) interface to the wireless medium (WM). The UE may be configured for communication in 3GPP related long term evolution (LTE), LTE-advanced, fifth generation (5G) wireless systems, such as new radio (NR), and their evolutions, as well as in IEEE related Wi-Fi, worldwide interoperability for microwave access (WiMAX) and their evolutions.

Furthermore, any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as previously mentioned a read-only memory (ROM), a programmable read-only memory (PROM), an erasable PROM (EPROM), a flash memory, an electrically erasable PROM (EEPROM), or a hard disk drive.

Moreover, it should be realized that the first communication device and the second communication device comprise the necessary communication capabilities in the form of e.g., functions, means, units, elements, etc., for performing or implementing embodiments of the invention. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the solution.

Therefore, the processor(s) of the first communication device and the second communication device may comprise, e.g., one or more instances of a central processing unit (CPU), a processing unit, a processing circuit, a processor, an application specific integrated circuit (ASIC), a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

1. A first communication device (100) comprising:
one or more processors configured to
modulate a first set of information bits (IB1) into a first number of modulated symbols (MS1) based on a predetermined probability distribution function,
map a second set of information bits (IB2) into a first number of sign bits (SB1),
multiply the first number of modulated symbols (MS1) with the first number of sign bits (SB1) into a first number of signed modulated symbols (SMS1);
modulate a third set of information bits (IB3) into a second number of modulated symbols (MS2) based on the predetermined probability distribution function,
map a fourth set of information bits (IB4) into a second number of sign bits (SB2),
multiply the second number of modulated symbols (MS2) with the second number of sign bits (SB2) into a second number of signed modulated symbols (SMS2);
form a set of complex-valued modulated symbols (CVMS) based on the first number of signed modulated symbols (SMS1) and the second number of signed modulated symbols (SMS2); and
de-map the set of complex modulated symbols (510) into a set of binary bits (BB).

2. The first communication device (100) according to claim 1, wherein the predetermined probability distribution function determines the occurrence of each amplitude in the first number of modulated symbols and in the second number of modulated symbols, respectively, from M number of predefined positive amplitudes.

3. The first communication device (100) according to claim 2, wherein the M number of predefined positive amplitudes are obtained from a pulse amplitude modulation.

4. The first communication device (100) according to claim 1, wherein the predetermined probability distribution function is a Gaussian or a near Gaussian probability distribution function.

5. The first communication device (100) according to claim 1, wherein the mapping of the second set of information bits (IB2) and the fourth set of information bits (IB4) comprises map an information bit 0 to a sign bit 1 and an information bit 1 to a sign bit −1, or vice versa.

6. The first communication device (100) according to claim 1, wherein the set of complex-valued modulated symbols (CVMS) are quadrature amplitude modulated symbols.

7. The first communication device (100) according to claim 1, configured to
encode the set of binary bits (BB) into a set of encoded bits (EB);
map the encoded bits (EB) into a set of complex-valued modulated symbols (510); and
transmit the set of complex-valued modulated symbols (510) to a second communication device (300).

8. The first communication device (100) according to claim 7, wherein the de-mapping of the set of complex-valued modulated symbols (CVMS) comprises an inverse operation to the mapping of the encoded bits (EB).

9. The first communication device (100) according to claim 7, configured to
transmit a control signal (520) to the second communication device (300), the control signal (520) indicating the predetermined probability density function, and a number symbols (N) in the first number of modulated symbols (MS1) and in the second number of modulated symbols (MS2).

10. The first communication device (100) according to claim 9, wherein the predetermined probability density function is represented as a Gaussian distribution.

11. A second communication device (300) comprising:
one or more processors configured to
receive a set of complex-valued modulated symbols (510) from a first communication device (100);
split the set of complex-valued modulated symbols (510) into a first number of signed modulated symbols (SMS1) and a second number of signed modulated symbols (SMS2);
split the first number of signed modulated symbols (SMS1) into a first number of sign bits (SB1) and a first number of modulated symbols (MS1),
demodulate the first number of modulated symbols (MS1) into a first set of information bits (IB1) based on a predetermined probability distribution function,
demodulate the first number of signed bits (SB) into a second set of information bits (IB2);
split the second number of signed modulated symbols (SMS2) into a second number of sign bits (SB2) and a second number of modulated symbols (MS2),
demodulate the second number of modulated symbols (MS2) into a third set of information bits (IB3) based on the predetermined probability distribution function, and
demodulate the second number of signed bits (SB2) into a fourth set of information bits (IB4).

12. The second communication device (300) according to claim 11, wherein the predetermined probability distribution function determines the occurrence of each amplitude in the first number of modulated symbols and in the second number of modulated symbols, respectively, from M number of predefined positive amplitudes.

13. The second communication device (300) according to claim 11, wherein the M number of predefined positive amplitudes are obtained from a pulse amplitude modulation.

14. The second communication device (300) according to claim 11, wherein the predetermined probability distribution function is a Gaussian or a near Gaussian probability distribution function.

15. The second communication device (300) according to claim 11, wherein the demodulating of the first number of signed bits (SB1) and the second number of signed bits (SB2) comprises map a sign bit 1 to an information bit 0 and a sign bit −1 to an information bit 1, or vice versa.

16. The second communication device (300) according to claim 11, wherein the set of complex-valued modulated symbols (CVMS) are quadrature amplitude modulated symbols.

17. The second communication device (300) according to claim 11, configured to
receive a control signal (520) from the first communication device (100), the control signal (520) indicating the predetermined probability density function, and the number symbols (N) in the first number of modulated symbols (MS1) and in the second number of modulated symbols (MS2); and
demodulate the first number of signed modulated symbols (SMS1) and the second number of signed modulated symbols (SMS2) based on the control signal (520).

18. The second communication device (300) according to claim 17, wherein the predetermined probability density function is represented as a Gaussian distribution.

19. The second communication device (300) according to claim 11, configured to
receive a control signal (520) from the first communication device (100), the control signal (520) indicating the occurrences of M number of predefined positive amplitudes (N₁, N₂, . . . , N_{M}) in the first number of modulated symbols (MS1) and in the second number of modulated symbols (MS2), respectively; and
demodulate the first number of signed modulated symbols (SMS1) and the second number of signed modulated symbols (SMS2) based on the control signal (520).

20. The second communication device (300) according to claim 11, configured to
receive a control signal (520) from the first communication device (100), the control signal (520) indicating a modulation and coding scheme associated with the transmission of the set of complex-valued modulated symbols (510); and
demodulate the first number of signed modulated symbols (SMS1) and the second number of signed modulated symbols (SMS2) based on the control signal (520).
